(19) United States
(12) Patent Application Publication
(10) Pub. No.: US 2022/0314514 A1
(43) Pub. Date: Oct. 6, 2022

(54) MOISTURE-CURABLE ADHESIVE COMPOSITIONS

(71) Applicant: 3M INNOVATIVE PROPERTIES COMPANY, St. Paul, MN (US)

(72) Inventors: David Goubard, Strasbourg (FR); Bérénice Stegel, Nordhouse (FR); Eric Schmitt, Strasbourg (FR)

(21) Appl. No.: 17/628,846

(22) PCT Filed: Jul. 14, 2020
(86) PCT No.: PCT/IB2020/056603

§ 371 Date: Jan. 20, 2022

(30) Foreign Application Priority Data
Jul. 23, 2019 (EP) 19187889.1

(51) Int. Cl. B29C 48/00; B29C 48/405; B29C 48/43; B29C 48/44; B29C 48/92; C08G 18/10; C08G 18/28; C08G 18/30; C08G 18/75; C08G 18/76; C08K 5/12; C09J 175/04

(52) U.S. Cl. CPC B29C 48/022; B29C 48/405; B29C 48/43; B29C 48/44; B29C 48/92; C08G 18/10; C08G 18/2865; C08G 18/307; C08G 18/758; C08G 18/7621; C08G 18/7671; C08K 5/12; C09J 175/04; B29C 2948/92704; B29C 2948/926; C08G 2170/00; C09J 2301/412; C09J 2301/408

(57) ABSTRACT

The present disclosure relates to a process of manufacturing a moisture-curable adhesive composition, wherein the process comprises the steps of: a) providing a multi-screw extruder comprising a reaction chamber; b) providing reactants and reagents comprising: i. at least one isocyanate; ii. at least one amine; and iii. optionally, at least one plasticizer; c) incorporating the reactants and reagents into the reaction chamber of the multi-screw extruder, thereby forming a reaction product comprising a urea derivative; and d) incorporating at least one moisture-curable prepolymer into the reaction product resulting from step c), thereby forming a moisture-curable adhesive composition. In another aspect, the present disclosure is directed to a moisture-curable adhesive composition obtainable by the process as described above.

### TECHNICAL FIELD

The present disclosure relates generally to the field of adhesives and sealants, more specifically to the field of moisture-curable adhesive compositions. The present disclosure also relates to a process of manufacturing such moisture-curable adhesive compositions and uses thereof.

### BACKGROUND

Moisture-curable adhesive compositions have been used for years as adhesive and sealants in particular for construction and industrial market applications. One typical production method for moisture-curable adhesive compositions involves a batch-wise process, whereby the reactants and reagents are introduced, either manually or through an automated system, into a high-intensity batch mixer. According to a first approach, it is made use of a two-step process using a moisture-curable prepolymer. In a first step, the main reactants for forming the prepolymer are pre-mixed in the desired ratio, optionally with several other ingredients, so as to form the prepolymer. In a second step, the prepolymer is mixed with the remaining reactants and reagents to achieve the final formulation. The prepolymer is typically formulated so that it can be used in various finished formulations. As a result, while both productions steps may occur in the same mixer, often a large quantity of the prepolymer is manufactured in a reactor for the first step and then transferred to one or more secondary mixers to make various finished batches. According to an alternative approach, a one-step manufacturing approach may be used, whereby all the reactants and reagents are sequentially introduced, either manually or through an automated system, into a single high-intensity batch mixer. In this approach, the order of addition of the various ingredients is crucial to control the finished product quality, and the finished formulation is typically transferred as such into the final packaging.

The batch-wise processes known in the art typically require stringent process requirements, including high-energy mixing, control of process careful of process conditions (in particular thermal and pressure management), and in particular means for preventing premature exposure to moisture and water (such as e.g. vacuum or chemical desiccation). In addition, the batch manufacturing approach is typically associated with various productivity limitations, such as e.g. waste production, intensive cleaning operations, in-line product quality testing, throughout limitations, complex equipment and safety issues management. All the limitations and stringent requirements detailed above make the use of batch-wise manufacturing processes inefficient and unattractive in various aspects.

In view of the above-detailed deficiencies associated with the batch manufacturing approach, alternative manufacturing processes such as continuous processes for the manufacturing of moisture-curable adhesive compositions have emerged as one approach to reduce these limitations. Exemplary continuous processes for the manufacturing of moisture-curable adhesive compositions are described e.g. in U.S. Pat. No. 5,621,024 (Eberhardt et al.), in U.S. Pat. No. 5,795,948 (Heidingsfeld et al.), and in U.S. Pat. No. 5,905,133 (Müller et al.).

Without contesting the technical advantages associated with the moisture-curable adhesive compositions known in the art, there is still a need for a robust, simple and cost-effective process of manufacturing a moisture-curable adhesive composition provided with excellent and versatile characteristics as to thixotropic and rheological properties.

### SUMMARY

According to one aspect, the present disclosure relates to a process of manufacturing a moisture-curable adhesive composition, wherein the process comprises the steps of:
a) providing a multi-screw extruder comprising a reaction chamber;
b) providing reactants and reagents comprising:
   i. at least one isocyanate;
   ii. at least one amine; and
   iii. optionally, at least one plasticizer;
c) incorporating the reactants and reagents into the reaction chamber of the multi-screw extruder, thereby forming a reaction product comprising a urea derivative; and
d) incorporating at least one moisture-curable prepolymer into the reaction product resulting from step c), thereby forming a moisture-curable adhesive composition.

In another aspect, the present disclosure relates to a moisture-curable adhesive composition obtainable by the process as described above.

According to still another aspect, the present disclosure relates to the use of a composition as described above for industrial applications, in particular for transportation market applications, more in particular automotive, marine, rail and aerospace applications, or for construction market applications.

### DETAILED DESCRIPTION

According to a first aspect, the present disclosure relates to a process of manufacturing a moisture-curable adhesive composition, wherein the process comprises the steps of:
a) providing a multi-screw extruder comprising a reaction chamber;
b) providing reactants and reagents comprising:
   i. at least one isocyanate;
   ii. at least one amine; and
   iii. optionally, at least one plasticizer;
c) incorporating the reactants and reagents into the reaction chamber of the multi-screw extruder, thereby forming a reaction product comprising a urea derivative; and
d) incorporating at least one moisture-curable prepolymer into the reaction product resulting from step c), thereby forming a moisture-curable adhesive composition.

In the context of the present disclosure, it has surprisingly been found that a process of manufacturing a moisture-curable adhesive composition as described above allows producing moisture-curable adhesive compositions provided with excellent and versatile characteristics as to rheo-thinning and other rheological properties (e.g. thixotropy), in particular with respect to extrusion rate, as well as sag and stringing resistance properties. The moisture-curable adhesive compositions directly resulting from the process of the present disclosure are in particular characterized by an optimal balance of extrusion rate and sag resistance properties.

In one advantageous aspect, the moisture-curable adhesive composition obtained by the process as described above is further characterized by any one of the following advantageous properties: excellent shelf life and storage stability, broad formulation flexibility, reduced product quality variability, reduced overall volatile organic compounds (VOC) content and reduced sensitivity to humidity.

The process of manufacturing a moisture-curable adhesive composition as described above is further characterized by any one of the following advantageous properties: continuous process using a single mixing and reacting equipment; use of regular and commonly available multi-screw extruder, reduced exposure of the various reactants and reagents to moisture, reduced exposure of the operators to hazardous material, reduced processing operations (in particular, maintenance, cleaning, loading and moving operations by manual operators), improved formulation flexibility, and enhanced production throughput.

Without wishing to be bound by theory, it is believed that this outstanding set of advantageous properties is directly derived from the process and the particular sequence of steps as described above. More particularly, it is believed that the particular step of forming a reaction product comprising a urea derivative by a so-called reactive extrusion step involving the step of incorporating reactants and reagents comprising at least one isocyanate and at least one amine into the reaction chamber of the multi-screw extruder, plays a determining role in obtaining these advantageous properties.

The urea derivative which is formed in-situ by reactive extrusion, formally acts as a thixotropic and rheo-thinning agent for the moisture-curable adhesive composition of the present disclosure, thereby helping the composition achieving, in particular, its excellent and versatile rheological properties. Advantageously, this particular process step allows producing moisture-curable adhesive compositions provided with relatively high viscosity, in particular having a viscosity up to 10.000 Pa·s, when measured at 23° C. with a rheometer in a shear flow mode at 0.1 s⁻¹. The in-situ formation of the urea derivative by reactive extrusion is further characterized by any one of the following advantageous properties: excellent formulation flexibility of the urea derivative, high chemical conversion of the initial reactants, excellent (high-)viscosity management, reduced exposure to humidity, excellent thermal management, and improved fine-tuning of the final composition properties.

Similarly, the particular step of incorporating at least one already-formed moisture-curable prepolymer into the reaction product comprising the urea derivative is also believed to play a decisive role in obtaining the advantageous properties detailed above. Incorporating an already-formed moisture-curable prepolymer not only reduces the complexity associated with the manufacturing of these prepolymers in multi-screw extruders, but also allows expanding the formulation flexibility and therefore fine-tuning the final adhesive formulation properties according to the intended application. Moreover, the step of incorporating the at least one moisture-curable prepolymer into the reaction product comprising the urea derivative acting as thixotropic agent is believed to advantageously affect not only the overall processing operations but also the ability to provide the moisture-curable adhesive composition with the beneficial properties as detailed above.

The moisture-curable adhesive compositions obtained by the process of the present disclosure are particularly suitable for the construction market applications, in particular for building, jointing or bonding various substrates such as e.g. facades. The moisture-curable adhesive compositions described herein are also suitable for industrial applications, in particular for construction and transportation market applications, more in particular automotive, naval, rail and aerospace applications. As such, the moisture-curable adhesive compositions according to the present disclosure are particularly suited for the manufacture of sandwich panels in the construction industry, and for windshield bonding in the automotive industry.

In the context of the present disclosure, the term “reaction chamber” is meant to refer to a closed region or area of the multi-screw extruder, comprising the multiple screws and where separate incoming addition streams are combined and contact one another. The reactants of the addition streams mix and chemically react with one another thereby forming a reaction product stream, where one or the other of the reactants may surround the other. The reaction chamber may contain several segments, each operating at the same or different working conditions, such as mixing and temperature regimes. Each segment may provide suitable addition ports for the various addition streams.

The term “addition stream” is meant to refer to reactants and reagents (such as e.g. the isocyanate, the amine or the moisture-curable prepolymer) flowing from an entry location to the reaction chamber of the multi-screw extruder.

The term “residence time” is meant to refer to the period of time the reaction product stream remains in the reaction chamber of the multi-screw extruder from the moment the reactants and reagents, are incorporated and mixed into the reaction chamber of the multi-screw extruder until the moment the reaction product stream exits the reaction chamber.

The process of the present disclosure comprises the step of providing a multi-screw extruder comprising a reaction chamber.

Multi-screw extruders for use herein are not particularly limited. Any multi-screw extruder comprising a reaction chamber commonly known in the art may be used in the context of the present disclosure. Suitable multi-screw extruders for use herein will be easily identified by those skilled in the art, in the light of the present description.

Moreover, multi-screw screw extrusion methods and devices have been well catalogued in recent publications such as in “Twin Screw Extrusion: Technology and Principles (2^{nd} Ed.), James L. White and Eung K. Kim, Carl Hanser Verlag, Munich 2010”, in “Co-rotating Twin-Screw Extruders: Fundamentals, Technology and Applications, Klemens Kohlgruber and Werner Wiedmann, Hanser, Munich 2008” or in “Reactive Extrusion: Principles and Applications, Günter Beyer and Christian Hopmann, Wiley-VCH, Weinheim 2017”. One suitable multi-screw extruder is commercially available, for example, under the trade designation PROCESS 11 PARALLEL TWIN-SCREW EXTRUDER (Thermo Fischer Scientific, Germany).

In a particular aspect of the present disclosure, the multi-screw extruder for use herein is selected from the group of twin-screw extruders, planetary roller extruders, and ring extruders. In that respect, the multi-screw extruder for use herein may be a co-rotating multi-screw extruder or a counter-rotating multi-screw extruder.

In one preferred aspect, the multi-screw extruder for use in the process according to the disclosure is a twin-screw extruder, in particular a co-rotating twin-screw extruder.

In an alternative execution, the multi-screw extruder for use herein is a planetary roller extruder comprising in particular a center spindle and multiple planetary gear spindles with center spindle and planetary gear spindles featuring a screw like geometry.

Selecting and fine-tuning the various operating parameters of the multi-screw extruder to the specifics of the targeted chemical reactions, is well within the capabilities of those skilled in the art. These operating parameters will typically be adapted, in particular, to the nature of the starting materials and the properties of the targeted moisture-curable adhesive composition.

In one exemplary aspect, the multi-screw extruder is operated at a screw speed in a range from 10 to 1200 rpm, from 20 to 1000 rpm, from 30 to 800 rpm, from 50 to 800 rpm, from 50 to 600 rpm, from 80 to 600 rpm, from 100 to 500 rpm, from 150 to 450 rpm, from 180 to 400 rpm, from 180 to 380 rpm, or even from 200 to 350 rpm.

The process of the present disclosure further comprises the step of providing reactants and reagents comprising:
i. at least one isocyanate;
ii. at least one amine; and
iii. optionally, at least one plasticizer.

Isocyanate and amine compounds for use herein are not particularly limited. Any isocyanate and amine compounds commonly known in the art may be used in the context of the present disclosure. Suitable isocyanate and amine compounds for use herein will be easily identified by those skilled in the art, in the light of the present description. Appropriate isocyanate and amine compounds for use herein will typically depend on the targeted properties of the resulting the reaction product comprising the urea derivative and on the specific characteristics intended for the moisture-curable adhesive composition that is ultimately obtained.

In an exemplary aspect, the at least one amine for use herein is selected from the group consisting of primary aliphatic, aromatic monoamines, aromatic diamines, and any combinations or mixtures thereof.

In one advantageous aspect, the at least one amine for use herein is selected from the group consisting of N-alkyl amines, aromatic monoamines, and any combinations or mixtures thereof.

According to a more advantageous aspect, the at least one amine for use herein is selected from the group consisting of N-butyl amine, benzylamine, and any combinations or mixtures thereof.

Exemplary isocyanates for use herein include, but are not limited to, aliphatic isocyanates, aromatic isocyanates, and any polymers, derivatives, combinations or mixtures thereof.

In one advantageous aspect of the disclosure, the at least one isocyanate for use herein is selected from the group consisting of difunctional isocyanates, in particular aliphatic or aromatic diisocyanates.

According to one more advantageous aspect, the at least one isocyanate for use herein is selected from the group of aliphatic diisocyanates, in particular from the group consisting of isophorone diisocyanate (IPDI), hexamethylene diisocyanate (HDI), methylenedicyclohexane diisocyanate (MDI), 4,4′-methylene dicyclohexyl diisocyanate (H12MDI), m-xylylene diisocyanate (XDI), tetramethylxylene diisocyanate (TMXDI), and any combinations or mixtures thereof.

According to one more advantageous aspect, the at least one isocyanate for use herein is selected from the group consisting of aromatic diisocyanates, in particular from the group consisting of diphenylmethane diisocyanate (MDI), toluene diisocyanate (TDI), and any mixtures thereof.

In a particular aspect, the at least one isocyanate for use herein may be present at least partially in a polymeric form, or in the form of a combination of isocyanates and polyisocyanates.

The reactants and reagents for use in the process of the present disclosure may further comprise at least one optional plasticizer.

Plasticizers for use herein are not particularly limited. Any plasticizers commonly known in the art may be used in the context of the present disclosure. Suitable plasticizers for use herein will be easily identified by those skilled in the art, in the light of the present description. Appropriate plasticizers for use herein will typically depend on the targeted properties of the resulting the reaction product comprising the urea derivative and on the specific characteristics intended for the moisture-curable adhesive composition that is ultimately obtained.

In one advantageous aspect, the at least one plasticizer for use herein is selected from the group consisting of phthalate-based plasticizers, phthalate-free plasticizers, and any mixtures thereof.

According to one more advantageous aspect, the at least one plasticizer for use herein is selected from the group consisting of phthalate-based plasticizers, in particular from the group consisting of diisodecyl phthalate (DIDP), diisodecyl terephthalate (DIDT), dibutyl phthalate (DBP), diisobutyl phthalate (DIBP), dibutyl terephthalate (DBT), diisobutyl terephthalate (DIBT), dioctyl phthalate (DOP), dioctyl terephthalate (DOTP), di-ethylhexyl phthalate (DEHP), di-ethylhexyl terephthalate (DEHT), diisononyl phthalate (DINP), diisononyl terephthalate (DINT), diisoundecyl phthalate (DIUP), diisoundecyl terephthalate (DIUT), dimethyl phthalate (DMP), dimethyl terephthalate (DMT), benzyl butyl phthalate (BBP), benzyl butyl terephthalate (BBT), di-ethylhexyl adipate (DEHA), and any mixtures thereof.

According to another more advantageous aspect, the at least one plasticizer for use herein is selected from the group consisting of phthalate-free plasticizers, in particular from the group consisting of 1,2 cyclohexane dicarboxylic acid diisononyl ester; sulfonate esters, in particular alkyl aryl sulfonates; phosphate esters, in particular triaryl and alkyl diaryl phosphates; benzoates, in particular benzoate and dibenzoate esters; maleate esters; trimellitate esters; and any combinations or mixtures thereof.

According to a particularly advantageous aspect, the at least one plasticizer for use herein is selected to comprise diisodecyl phthalate (DIDP).

The process of the present disclosure further comprises the step of incorporating the reactants and reagents into the reaction chamber of the multi-screw extruder, thereby forming a reaction product comprising a urea derivative.

According to a typical aspect of the present disclosure, the urea derivative comprised in the reaction product is (or acts as) a thixotropic agent for the moisture-curable adhesive composition, thereby helping the composition achieving, in particular, its excellent and versatile rheological properties. According to still a typical aspect of the present disclosure, the urea derivative is formed in-situ by a so-called reactive extrusion process.

According to a beneficial aspect of the present disclosure, the urea derivative comprised in the reaction product for use herein is a polyfunctional urea derivative (or a polyurea), in particular a difunctional urea derivative.

In one advantageous aspect of the process of the disclosure, the urea derivative comprised in the reaction product for use herein has a weight average molecular weight (M_{w}) in a range from 100 to 1000 g/mol, from 100 to 800 g/mol, from 150 to 750 g/mol, from 200 to 700 g/mol, from 200 to 600 g/mol, from 250 to 550 g/mol, from 250 to 500 g/mol, or even from 300 to 500 g/mol.

In another advantageous aspect of the process of the disclosure, the reaction product comprising the urea derivative is in the form of a (gel) paste having in particular a viscosity greater than 5000 Pa·s, greater than 10.000 Pa·s, greater than 20.000 Pa·s, greater than 30.000 Pa·s, greater than 50.000 Pa·s, greater than 70.000 Pa·s, or even greater than 90.000 Pa·s, when measured at 23° C. with a rheometer in a shear flow mode at 0.1 s⁻¹.

The above-mentioned viscosity ranges for the reaction product comprising the urea derivative are particularly advantageous to ensure good rheological properties prior to incorporation of the at least one moisture-curable prepolymer, as well as excellent dispersion of the at least one moisture-curable prepolymer after incorporation into the reaction product comprising the urea derivative.

In an advantageous aspect of the disclosure, the at least one optional plasticizer may be appropriately used to modulate and achieve the suitable rheological properties, in particular suitable viscosity, of the reaction product comprising the urea derivative prior to incorporation of the at least one moisture-curable prepolymer.

According to another advantageous aspect, the process of the present disclosure may further comprise the step of pre-mixing the amine and the optional plasticizer, in particular in a static mixing element, before incorporation into the reaction chamber of the multi-screw extruder.

According to still another advantageous aspect, the process of the present disclosure may further comprise the step of pre-mixing the isocyanate and the optional plasticizer, in particular in a static or dynamic mixing element, before incorporation into the reaction chamber of the multi-screw extruder.

The process of the present disclosure further comprises the step of incorporating at least one moisture-curable prepolymer into the reaction product resulting from step c), thereby forming a moisture-curable adhesive composition.

Moisture-curable prepolymers for use herein are not particularly limited. Any moisture-curable prepolymers commonly known in the art may be used in the context of the present disclosure. Suitable moisture-curable prepolymers for use herein will be easily identified by those skilled in the art, in the light of the present description. Appropriate moisture-curable prepolymers for use herein will typically depend on the targeted properties and specific characteristics of the moisture-curable adhesive composition that is ultimately obtained.

According to an advantageous aspect of the disclosure, the at least one moisture-curable prepolymer for use herein is selected from the group consisting of isocyanate-terminated moisture-curable prepolymers and silane-modified moisture-curable prepolymers.

According to a more advantageous aspect of the disclosure, the at least one moisture-curable prepolymer for use herein is selected from the group consisting of isocyanate-terminated moisture-curable prepolymers, silane-terminated moisture-curable prepolymers, and any combinations or mixtures thereof.

In one particularly advantageous aspect of the disclosure, the at least one moisture-curable prepolymer for use herein is selected from the group consisting of isocyanate-terminated moisture-curable prepolymers.

In another particularly advantageous aspect of the disclosure, the at least one moisture-curable prepolymer for use herein is selected from the group consisting of silane-modified moisture-curable prepolymers, in particular from the group consisting of silane-modified polyether prepolymers, silane-terminated polyether prepolymers, silane-modified polyurethane prepolymers, silane-terminated polyurethane prepolymers, and any combinations or mixtures thereof.

According to a beneficial aspect, the at least one moisture-curable prepolymer for use in the present disclosure has a weight average molecular weight in a range from 50 to 100.000 g/mol, from 100 to 75.000 g/mol, from 100 to 50.000 g/mol, from 1000 to 50.000 g/mol, from 5000 to 50.000 g/mol, from 10.000 to 50.000 g/mol, or even from 20.000 to 50.000 g/mol.

In one particular aspect of the process of the disclosure, the at least one moisture-curable prepolymer is advantageously introduced in the downstream section of the multi-screw extruder, in particular outside the reaction chamber of the multi-screw extruder. This beneficial execution ensures, in particular, that the moisture-curable prepolymer does not enter into unwanted reactions with the reactants initially introduced into the reaction chamber of the multi-screw extruder.

According to a particularly advantageous aspect, the process of the present disclosure allows producing moisture-curable adhesive compositions provided with relatively high viscosity.

In one advantageous aspect, the moisture-curable adhesive composition of the present disclosure has a viscosity greater than 100 Pa·s, greater than 300 Pa·s, greater than 500 Pa·s, greater than 800 Pa·s, greater than 1000 Pa·s, greater than 1500 Pa·s, greater than 2000 Pa·s, greater than 2500 Pa·s, greater than 3000 Pa·s, greater than 3500 Pa·s, greater than 4000 Pa·s, greater than 5000 Pa·s, greater than 6000 Pa·s, greater than 7000 Pa·s, greater than 8000 Pa·s, greater than 9000 Pa·s, or even greater than 9500 Pa·s, when measured at 23° C. with a rheometer in a shear flow mode at 0.1 s⁻¹.

In another advantageous aspect of the present disclosure, the moisture-curable adhesive composition has a viscosity in a range from 100 to 10.000 Pa·s, from 100 to 8000 Pa·s, from 100 to 6000 Pa·s, from 100 to 5000 Pa·s, from 100 to 4000 Pa·s, from 200 to 3500 Pa·s, from 500 to 3000 Pa·s, from 1000 to 2500 Pa·s, or even from 1500 to 2000 Pa·s, when measured at 23° C. with a rheometer in a shear flow mode at 0.1 s⁻¹.

Advantageously, the moisture-curable adhesive composition of the present disclosure is a one-component moisture-curable adhesive composition, which beneficially takes the form of a smooth pasty composition provided with well dispersed urea derivative material.

According to a typical aspect, the process of the present disclosure further comprises the step of curing or allowing the moisture-curable adhesive composition to cure, in particular moisture curing the moisture-curable adhesive composition. The step of curing or allowing the moisture-curable adhesive composition to cure is typically performed after the moisture-curable adhesive composition has been applied to the substrate(s) to which it is intended to provide its adhesion properties.

As will be easily apparent to those skilled in the art, the moisture-curable adhesive composition of the present disclosure may comprise further additives, in amounts typically used in the field of application, to impart certain desirable characteristics and properties to the moisture-curable adhesive compositions. Exemplary additives for use herein include, but are not limited to, fillers, fibers, further plasticizers, further thixotropic agents, adhesion promoters, moisture scavengers, tackifying systems, stabilizers, fungicides, antioxidants, pigments, catalysts, UV stabilizers, rheology modifiers, flame retardants, biocides or wetting agents.

Accordingly, and in one advantageous aspect of the disclosure, the process further comprises the step of incorporating further additives into the reaction product resulting from step c).

According to a more advantageous aspect, the further additives are introduced into the reaction product resulting from step c) before the step of incorporating the at least one moisture-curable prepolymer into the reaction product.

In one particular aspect, the additives for use in the process according to the disclosure are selected from the group consisting of fillers, further plasticizers, further thixotropic agents, adhesion promoters, moisture scavengers, tackifying systems, stabilizers, fungicides, antioxidants, pigments, catalysts, and any mixtures thereof.

In an advantageous aspect of the disclosure, the additives for use in the process are selected from the group consisting of particulate fillers, in particular organic and inorganic particulate fillers, moisture scavengers, adhesion promoters, and any combinations or mixtures thereof.

In a more advantageous aspect, the additives for use herein are selected from the group consisting of inorganic particulate fillers, in particular from the group consisting of calcium carbonates, in particular ground or precipitated calcium carbonate, optionally coated with fatty acids or fatty esters; magnesium hydroxides; aluminum oxides; aluminum trihydrates; lime; kaolin; silica-based filers, in particular fumed silica, precipitated silica, pyrogenated silica; titanium dioxide; microspheres, in particular glass bubbles and hollow glass microspheres; and any combinations or mixtures thereof.

In another more advantageous aspect, the additives for use herein are selected from the group consisting of organic particulate fillers, in particular from the group consisting of carbon black, PVC powders or flakes, fibres, in particular polyethylene fibres, and any mixtures thereof.

In a particularly advantageous aspect of the disclosure, the additives for use herein are selected to comprise calcium carbonates, in particular ground calcium carbonates.

According to the advantageous aspect whereby the process further comprises the step of incorporating inorganic particulate fillers into the reaction product, the process may advantageously further comprise the step of pre-drying the inorganic fillers before incorporating into the reaction product resulting from step c). In one advantageous aspect, the step of pre-drying the inorganic fillers is performed by thermal treatment, and in particular in a dynamic mode at temperatures typically greater than 90° C. In another advantageous aspect, the step of pre-drying the inorganic fillers may involve applying selected vacuum conditions.

Advantageously still, the pre-dried inorganic fillers for use herein may be beneficially introduced in the downstream section of the multi-screw extruder, in particular outside the reaction chamber of the multi-screw extruder.

Selecting and fine-tuning the various operating parameters of the multi-screw extruder and the processing conditions, is well within the capabilities of those skilled in the art of formulating moisture-curable adhesive compositions. These operating parameters will typically be adapted, in particular, to the nature of the starting materials and the properties of the targeted moisture-curable adhesive composition.

According to an exemplary aspect of the process according to the disclosure, the temperature of the reaction chamber is in a range from 0° C. to 150° C., from 0° C. to 120° C., from 0° C. to 100° C., from 0° C. to 80° C., from 0° C. to 70° C., from 5° C. to 60° C., from 10° C. to 60° C., from 15° C. to 60° C., from 15° C. to 55° C., from 15° C. to 50° C., or even from 15° C. to 40° C., after incorporation of the reactants and reagents, and in particular the isocyanate, the amine and the optional plasticizer.

According to another exemplary aspect of the process, the temperature of the reaction chamber is advantageously no greater than 150° C., no greater than 120° C., no greater than 100° C., no greater than 80° C., no greater than 60° C., no greater than 50° C., or even no greater than 40° C., after incorporation of the reactants and reagents, and in particular the isocyanate, the amine and the optional plasticizer.

In one advantageous aspect of the process, the residence time of the reaction product stream comprising the urea derivative in the reaction chamber of the multi-screw extruder is in a range from 1 to 120 seconds, from 1 to 90 seconds, from 2 to 60 seconds, from 2 to 30 seconds, from 2 to 25 seconds, from 3 to 20 seconds, from 3 to 15 seconds, from 3 to 10 seconds, or even from 5 to 10 seconds.

In another advantageous aspect of the process, the residence time of the reaction product stream comprising the urea derivative in the reaction chamber of the multi-screw extruder is no greater than 120 seconds, no greater than 90 seconds, no greater than 60 seconds, no greater than 30 seconds, no greater than 25 seconds, no greater than 20, no greater than 15, or even no greater than 10 seconds.

In a particular aspect, the moisture-curable adhesive composition obtained by the process of the present disclosure comprises:
a) from 2 to 80 wt. %, from 5 to 80 wt. %, from 5 to 70 wt. %, from 10 to 70 wt. %, from 10 to 60 wt. %, from 15 to 55 wt. %, from 20 to 55 wt. %, from 20 to 50 wt. %, from 25 to 45 wt. %, or even from 25 to 40 wt. %, of the reaction product comprising a urea derivative and resulting from step c);
b) from 10 to 50 wt. %, from 10 to 45 wt. %, from 15 to 40 wt. %, from 15 to 35 wt. %, from 15 to 30 wt. %, or even from 20 to 30 wt. %, of the at least one moisture-curable prepolymer; and
c) optionally, from 10 to 50 wt. %, from 10 to 45 wt. %, from 15 to 40 wt. %, from 15 to 35 wt. %, from 15 to 30 wt. %, or even from 20 to 30 wt. %, of particulate fillers, in particular particulate inorganic fillers.

In another aspect, the present disclosure relates to a moisture-curable adhesive composition obtainable by the process as described above.

According to an advantageous aspect, the moisture-curable adhesive composition according to the present disclosure has a viscosity greater than 100 Pa·s, greater than 300 Pa·s, greater than 500 Pa·s, greater than 800 Pa·s, greater than 1000 Pa·s, greater than 1500 Pa·s, greater than 2000 Pa·s, greater than 2500 Pa·s, greater than 3000 Pa·s, greater than 3500 Pa·s, greater than 4000 Pa·s, greater than 5000 Pa·s, greater than 6000 Pa·s, greater than 7000 Pa·s, greater than 8000 Pa·s, greater than 9000 Pa·s, or even greater than 9500 Pa·s, when measured at 23° C. with a rheometer in a shear flow mode at 0.1 s⁻¹.

According to another advantageous aspect, the moisture-curable adhesive composition has a viscosity in a range from 100 to 10,000 Pa·s, from 100 to 8000 Pa·s, from 100 to 6000 Pa·s, from 100 to 5000 Pa·s, from 100 to 4000 Pa·s, from 200 to 3500 Pa·s, from 500 to 3000 Pa·s, from 1000 to 2500 Pa·s, or even from 1500 to 2000 Pa·s, when measured at 23° C. with a rheometer in a shear flow mode at 0.1 s⁻¹.

According to another advantageous aspect, the moisture-curable adhesive composition of the disclosure has a shelf life greater than 6 months, greater than 9 months, greater than 12 months, or even greater than 18 months, or even greater than 24 months, when determined according to the test method described in the experimental section.

According to still another aspect, the present disclosure relates to the use of a composition as described above for industrial applications, in particular for transportation market applications, more in particular automotive, marine, rail and aerospace applications, or for construction market applications.

According to yet another aspect, the present disclosure relates to the use of a moisture-curable prepolymer for the manufacturing of a moisture-curable adhesive composition in a multi-screw extruder, wherein the moisture-curable adhesive composition comprises a urea derivative as a thixotropic agent.

Item 1 is a (continuous) process of manufacturing a moisture-curable adhesive composition, wherein the process comprises the steps of:
a) providing a multi-screw extruder comprising a reaction chamber;
b) providing reactants and reagents comprising:
   i. at least one isocyanate;
   ii. at least one amine; and
   iii. optionally, at least one plasticizer;
c) incorporating the reactants and reagents into the reaction chamber of the multi-screw extruder, thereby forming a reaction product comprising a urea derivative; and
d) incorporating at least one moisture-curable prepolymer into the reaction product resulting from step c), thereby forming (a precursor of) a moisture-curable adhesive composition.

Item 2 is a process according to item 1, wherein the at least one moisture-curable prepolymer is selected from the group consisting of isocyanate-terminated moisture-curable prepolymers and silane-modified moisture-curable prepolymers.

Item 3 is a process according to any of item 1 or 2, wherein the at least one moisture-curable prepolymer is selected from the group consisting of isocyanate-terminated moisture-curable prepolymers, silane-terminated moisture-curable prepolymers, and any combinations or mixtures thereof.

Item 4 is a process according to any of the preceding items, wherein the at least one moisture-curable prepolymer is selected from the group consisting of isocyanate-terminated moisture-curable prepolymers.

Item 5 is a process according to any of items 1 to 3, wherein the at least one moisture-curable prepolymer is selected from the group consisting of silyl-modified moisture-curable prepolymers, in particular from the group consisting of silane-modified polyether prepolymers, silane-terminated polyether prepolymers, silane-modified polyurethane prepolymers, silane-terminated polyurethane prepolymers, and any combinations or mixtures thereof.

Item 6 is a process according to any of the preceding items, wherein the at least one moisture-curable prepolymer is introduced in the downstream section of the multi-screw extruder, in particular outside the reaction chamber of the multi-screw extruder.

Item 7 is a process according to any of the preceding items, wherein the at least one moisture-curable prepolymer has a weight average molecular weight in a range from 50 to 100.000 g/mol, from 100 to 75.000 g/mol, from 100 to 50.000 g/mol, from 1000 to 50.000 g/mol, from 5000 to 50.000 g/mol, from 10.000 to 50.000 g/mol, or even from 20.000 to 50.000 g/mol.

Item 8 is a process according to any of the preceding items, wherein the moisture-curable adhesive composition has a viscosity greater than 100 Pa·s, greater than 300 Pa·s, greater than 500 Pa·s, greater than 800 Pa·s, greater than 1000 Pa·s, greater than 1500 Pa·s, greater than 2000 Pa·s, greater than 2500 Pa·s, greater than 3000 Pa·s, greater than 3500 Pa·s, greater than 4000 Pa·s, greater than 5000 Pa·s, greater than 6000 Pa·s, greater than 7000 Pa·s, greater than 8000 Pa·s, greater than 9000 Pa·s, or even greater than 9500 Pa·s, when measured at 23° C. with a rheometer in a shear flow mode at 0.1 s⁻¹.

Item 9 is process according to any of the preceding items, wherein the moisture-curable adhesive composition has a viscosity in a range from 100 to 10,000 Pa·s, from 100 to 8000 Pa·s, from 100 to 6000 Pa·s, from 100 to 5000 Pa·s, from 100 to 4000 Pa·s, from 200 to 3500 Pa·s, from 500 to 3000 Pa·s, from 1000 to 2500 Pa·s, or even from 1500 to 2000 Pa·s, when measured at 23° C. with a rheometer in a shear flow mode at 0.1 s⁻¹.

Item 10 is a process according to any of the preceding items, wherein the urea derivative is a thixotropic agent.

Item 11 is a process according to any of the preceding items, wherein the reaction product comprising the urea derivative is in particular in the form of a (gel) paste having a viscosity greater than 5000 Pa·s, greater than 10.000 Pa·s, greater than 20.000 Pa·s, greater than 30.000 Pa·s, greater than 50.000 Pa·s, greater than 70.000 Pa·s, or even greater than 90.000 Pa·s, when measured at 23° C. with a rheometer in a shear flow mode at 0.1 s⁻¹.

Item 12 is a process according to any of the preceding items, wherein the at least one amine is selected from the group consisting of primary aliphatic, aromatic monoamines, aromatic diamines, and any combinations or mixtures thereof.

Item 13 is a process according to any of the preceding items, wherein the at least one amine is selected from the group consisting of N-alkyl amines, aromatic monoamines, and any combinations or mixtures thereof.

Item 14 is a process according to any of the preceding items, wherein the at least one amine is selected from the group consisting of N-butyl amine, benzylamine, and any combinations or mixtures thereof.

Item 15 is a process according to any of the preceding items, wherein the at least one isocyanate is selected from the group consisting of difunctional isocyanates, in particular aliphatic or aromatic diisocyanates, and any combinations or mixtures thereof.

Item 16 is a process according to any of the preceding items, wherein the at least one isocyanate is selected from the group of aliphatic diisocyanates, in particular from the group consisting of isophorone diisocyanate (IPDI), hexamethylene diisocyanate (HDI), 4,4′-Methylene dicyclohexyl diisocyanate (H12MDI), and any combinations or mixtures thereof.

Item 17 is a process according to any of the preceding items, wherein the at least one isocyanate is selected from the group consisting of aromatic diisocyanates, in particular from the group consisting of diphenylmethane diisocyanate (MDI), toluene diisocyanate (TDI), and any mixtures thereof.

Item 18 is a process according to any of the preceding items, wherein the urea derivative is a polyfunctional urea derivative, in particular a difunctional urea derivative. Item 19 is a process according to any of the preceding items, wherein the plasticizer is selected from the group consisting of phthalate-based plasticizers, phthalate-free plasticizers, and any mixtures thereof.

Item 20 is a process according to any of the preceding items, wherein the plasticizer is selected from the group consisting of phthalate-based plasticizers, in particular from the group consisting of diisodecyl phthalate (DIDP), diisodecyl terephthalate (DIDT), dibutyl phthalate (DBP), diisobutyl phthalate (DIBP), dibutyl terephthalate (DBT), diisobutyl terephthalate (DIBT), dioctyl phthalate (DOP), dioctyl terephthalate (DOTP), di-ethylhexyl phthalate (DEHP), di-ethylhexyl terephthalate (DEHT), diisononyl phthalate (DINP), diisononyl terephthalate (DINT), diisoundecyl phthalate (DIUP), diisoundecyl terephthalate (DIUT), dimethyl phthalate (DMP), dimethyl terephthalate (DMT), benzyl butyl phthalate (BBP), benzyl butyl terephthalate (BBT), di-ethylhexyl adipate (DEHA), and any mixtures thereof.

Item 21 is a process according to any of the preceding items, wherein the at least one plasticizer is selected from the group consisting of phthalate-free plasticizers, in particular from the group consisting of 1,2 cyclohexane dicarboxylic acid diisononyl ester; sulfonate esters, in particular alkyl aryl sulfonates; phosphate esters, in particular triaryl and alkyl diaryl phosphates; benzoates, in particular benzoate and dibenzoate esters; maleate esters; trimellitate esters; and any combinations or mixtures thereof.

Item 22 is a process according to any of items 1 to 20, wherein the at least one plasticizer is selected to comprise diisodecyl phthalate (DIDP).

Item 23 is a process according to any of the preceding items, wherein the moisture-curable adhesive composition is a one-component moisture-curable adhesive composition.

Item 24 is a process according to any of the preceding items, wherein the multi-screw extruder is selected from the group of twin-screw extruders, planetary roller extruders, and ring extruders.

Item 25 is a process according to any of the preceding items, wherein the multi-screw extruder is operated at a screw speed in a range from 10 to 1200 rpm, from 20 to 1000 rpm, from 30 to 800 rpm, from 50 to 800 rpm, from 50 to 600 rpm, from 80 to 600 rpm, from 100 to 500 rpm, from 150 to 450 rpm, from 180 to 400 rpm, from 180 to 380 rpm, or even from 200 to 350 rpm.

Item 26 is a process according to any of the preceding items, wherein the multi-screw extruder is a co-rotating multi-screw extruder.

Item 27 is a process according to any of items 1 to 25, wherein the multi-screw extruder is a counter-rotating multi-screw extruder.

Item 28 is a process according to any of items 1 to 26, wherein the multi-screw extruder is a twin-screw extruder, in particular a co-rotating twin-screw extruder.

Item 29 is a process according to any of items 1 to 28, wherein the multi-screw extruder is a planetary roller extruder comprising in particular a center spindle and multiple planetary gear spindles with center spindle and planetary gear spindles featuring a screw like geometry.

Item 30 is a process according to any of the preceding items, which further comprises the step of curing the (precursor of the) moisture-curable adhesive composition, in particular moisture curing the (precursor of the) moisture-curable adhesive composition.

Item 31 is a process according to any of the preceding items, which further comprises the step of pre-mixing the amine and the optional plasticizer, in particular in a static mixing element, before incorporation into the reaction chamber of the multi-screw extruder.

Item 32 is a process according to any of the preceding items, which further comprises the step of pre-mixing the isocyanate and the optional plasticizer, in particular in a static or dynamic mixing element, before incorporation into the reaction chamber of the multi-screw extruder.

Item 33 is a process according to any of the preceding items, which further comprises the step of incorporating further additives into the reaction product resulting from step c), in particular before the step of incorporating the at least one moisture-curable prepolymer into the reaction product.

Item 34 is a process according to item 33, wherein the additives are selected from the group consisting of fillers, further plasticizers, further thixotropic agents, adhesion promoters, moisture scavengers, tackifying systems, stabilizers, fungicides, antioxidants, pigments, catalysts, and any mixtures thereof.

Item 35 is a process according to any of item 33 or 34, wherein the additives are selected from the group consisting of particulate fillers, in particular organic and inorganic particulate fillers, moisture scavengers, adhesion promoters, and any combinations or mixtures thereof.

Item 36 is a process according to any of items 33 to 35, wherein the additives are selected from the group consisting of inorganic particulate fillers, in particular from the group consisting of calcium carbonates, in particular ground or precipitated calcium carbonate, optionally coated with fatty acids or fatty esters; magnesium hydroxides; aluminum oxides; aluminum trihydrates; lime; kaolin; silica-based filers, in particular fumed silica, precipitated silica, pyrogenated silica; titanium dioxide; microspheres, in particular glass bubbles and hollow glass microspheres; and any combinations or mixtures thereof.

Item 37 is a process according to any of items 33 to 35, wherein the additives are selected from the group consisting of organic particulate fillers, in particular from the group consisting of carbon black, PVC suspensions or emulsions, fibers, in particular polyethylene fibers, and any mixtures thereof.

Item 38 is a process according to any of items 33 to 36, wherein the additives are selected to comprise calcium carbonates, in particular ground calcium carbonates.

Item 39 is a process according to item 36, which further comprises the step of (thermally) pre-drying the inorganic fillers before incorporating into the reaction product resulting from step c).

Item 40 is a process according to item 39, wherein the pre-dried inorganic fillers are introduced in the downstream section of the multi-screw extruder, in particular outside the reaction chamber of the multi-screw extruder.

Item 41 is a process according to any of the preceding items, wherein the (precursor of a) moisture-curable adhesive composition comprises:
a) from 2 to 80 wt. %, from 5 to 80 wt. %, from 5 to 70 wt. %, from 10 to 70 wt. %, from 10 to 60 wt. %, from 15 to 55 wt. %, from 20 to 55 wt. %, from 20 to 50 wt. %, from 25 to 45 wt. %, or even from 25 to 40 wt. %, of the reaction product comprising a urea derivative and resulting from step c);
b) from 10 to 50 wt. %, from 10 to 45 wt. %, from 15 to 40 wt. %, from 15 to 35 wt. %, from 15 to 30 wt. %, or even from 20 to 30 wt. %, of the at least one moisture-curable prepolymer; and
c) optionally, from 10 to 50 wt. %, from 10 to 45 wt. %, from 15 to 40 wt. %, from 15 to 35 wt. %, from 15 to 30 wt. %, or even from 20 to 30 wt. %, of particulate fillers, in particular particulate inorganic fillers.

Item 42 is a process according to any of the preceding items, wherein the temperature of the reaction chamber is in a range from 0° C. to 150° C., from 0° C. to 120° C., from 0° C. to 100° C., from 0° C. to 80° C., from 0° C. to 70° C., from 5° C. to 60° C., from 10° C. to 60° C., from 15° C. to 60° C., from 15° C. to 55° C., from 15° C. to 50° C., or even from 15° C. to 40° C., after incorporation of the reactants and reagents, and in particular the isocyanate, the amine and the optional plasticizer.

Item 43 is a process according to any of the preceding items, wherein the temperature of the reaction chamber is no greater than 150° C., no greater than 120° C., no greater than 100° C., no greater than 80° C., no greater than 60° C., no greater than 50° C., or even no greater than 40° C., after incorporation of the reactants and reagents, and in particular the isocyanate, the amine and the optional plasticizer.

Item 44 is a process according to any of the preceding items, wherein the residence time of the reaction product stream comprising the urea derivative in the reaction chamber of the multi-screw extruder is in a range from 1 to 120 seconds, from 1 to 90 seconds, from 2 to 60 seconds, from 2 to 30 seconds, from 2 to 25 seconds, from 3 to 20 seconds, from 3 to 15 seconds, from 3 to 10 seconds, or even from 5 to 10 seconds.

Item 45 is a process according to any of the preceding items, wherein the residence time of the reaction product stream comprising the urea derivative in the reaction chamber of the multi-screw extruder is no greater than 120 seconds, no greater than 90 seconds, no greater than 60 seconds, no greater than 30 seconds, no greater than 25 seconds, no greater than 20, no greater than 15, or even no greater than 10 seconds.

Item 46 is a moisture-curable adhesive composition obtainable by the process according to any of the preceding items.

Item 47 is a composition according to item 46, which has a viscosity greater than 100 Pa·s, greater than 300 Pa·s, greater than 500 Pa·s, greater than 800 Pa·s, greater than 1000 Pa·s, greater than 1500 Pa·s, greater than 2000 Pa·s, greater than 2500 Pa·s, greater than 3000 Pa·s, greater than 3500 Pa·s, greater than 4000 Pa·s, greater than 5000 Pa·s, greater than 6000 Pa·s, greater than 7000 Pa·s, greater than 8000 Pa·s, greater than 9000 Pa·s, or even greater than 9500 Pa·s, when measured at 23° C. with a rheometer in a shear flow mode at 0.1 s⁻¹.

Item 48 is a composition according to any of item 46 or 47, which has a viscosity in a range from 100 to 10,000 Pa·s, from 100 to 8000 Pa·s, from 100 to 6000 Pa·s, from 100 to 5000 Pa·s, from 100 to 4000 Pa·s, from 200 to 3500 Pa·s, from 500 to 3000 Pa·s, from 1000 to 2500 Pa·s, or even from 1500 to 2000 Pa·s, when measured at 23° C. with a rheometer in a shear flow mode at 0.1 s⁻¹.

Item 49 is a composition according to any of items 46 to 48, which has a shelf life greater than 6 months, greater than 9 months, greater than 12 months, or even greater than 18 months, or even greater than 24 months, when determined according to the test method described in the experimental section.

Item 50 is the use of a composition according to any of items 46 to 49 for industrial applications, in particular for transportation market applications, more in particular automotive, marine, rail and aerospace applications, or for construction market applications.

Item 51 is the use of a moisture-curable prepolymer for the (continuous) manufacturing of a moisture-curable adhesive composition in a multi-screw extruder, wherein the moisture-curable adhesive composition comprises a urea derivative as a thixotropic agent.

### EXAMPLES

The invention is further illustrated by the following examples. These examples are merely for illustrative purposes only and are not meant to be limiting on the scope of the appended claims.

Test Methods and Procedures:

Shelf Life

Shelf life of the moisture-curable compositions according to the present disclosure is determined upon storage at ambient conditions (23° C. and 50% relative humidity) and after accelerated ageing conditions (5 days at 60° C. and 50% relative humidity) according to the following criteria: visual aspect, reactivity, extrusion rate and viscosity after ageing are checked, and should remain unchanged.

Weight Average Molecular Weight measurement (M_{w})

The weight average molecular weight and number average molecular weight of the polymers are determined using conventional gel permeation chromatography (GPC). The GPC apparatus obtained from Waters, include a high-pressure liquid chromatography pump (Model 600E), an auto-sampler (Model 712 WISP), and a refractive index detector (Model 2414). The chromatograph is equipped with three Mixed Bed type B (10 μm particle) columns 300×7.5 mm from Agilent. The weight average molecular weight (Mw) is calculated for each sample from the calibration curve.

Equipment Employed:

The experiments and reactions are performed using a 20-mm twin-screw co-rotating extruder available under the trade designation Omega 20, from Steer, India.

Materials Employed:

Desmodur T80: 2,4- and 2,6-toluene diisocyanate (TDI) mixture in a 80:20 ratio, commercially available from Covestro, Germany.

Ongronat 3050: 4,4′-methylene bis(phenylisocyanate) (MDI), commercially available from BorsodChem, Hungary.

Vestanat H12MDI: 4,4′-Methylene dicyclohexyl diisocyanate, commercially available from Evonik, Germany.

Benzylamine: monoamine, commercially available from BASF, Germany. n-Butylamine: monoamine, commercially available from BASF, Germany.

PU prepolymer: MDI polyurethane prepolymer having a weight average molecular weight of about 36.000 g/mol, which may be obtained from 3M France, Haguenau.

Jayflex DIDP: Diisodecyl phthalate, plasticizer commercially available from ExxonMobil, Germany. Omyacarb 5GU: calcium carbonate filler, commercially available from Omya, France.

Sachtleben RFK2: titanium oxide-based filler, commercially available from Venator, Germany.

Microspheres S38: hollow glass microspheres, commercially available from the 3M Company.

Benzoyl chloride: stabilizer, commercially available from Sigma-Aldrich.

Additive Ti: Moisture scavenger, commercially available from Borchers, Germany.

Dynasylan Glymo: silane-based adhesion promotor, commercially available from Evonik, Germany.

General Preparation of the Moisture-Curable Adhesive Composition:

A 20-mm diameter co-rotating twin screw extruder, commercially available as «Omega 20» from Steer India, is used to prepare the moisture-curable adhesive compositions. The twin screw extruder has 10 zones, each corresponding to one tenth of the length of the screw. Total process length of the extruder is 60 diameters (1200 mm). The twin screw extruder is operated at 600 rpm, at 45° C. in zone 1 and 2, at 65° C. in zone 3, at 70° C. in zone 4, at 65° C. in zone 5, and at 60° C. in zones 6 to 10. The portion of the plasticizer is fed from a nitrogen inerted tank through a gear pump (Zenith B9000 series) and Coriolis flowmeter (Micromotion) into zone 1 at 8.45 g/min. A 2:1 ratio of the plasticizer to the isocyanate is fed via a similar setup to zone 2 of the extruder at 8.91 g/min. The amine is fed into zone 3 of the extruder via a Harvard syringe pump through a Coriolis (Bronkhorst) flowmeter at 1.72 g/min. The calcium carbonate is fed at 30.92 g/min via a K-Tron T20 feeder (Coperion) through a side stuffer into zone 5 of the extruder. The PU prepolymer is fed via an inerted holding tank through a gear pump and flowmeter at a rate of 22.14 g/min into zone 8 of the extruder. The glass bubbles are fed via a K-Tron T20 feeder through a side stuffer into zone 9 of the extruder at a rate of 3.55 g/min. The resulting material is discharged through a discharge valve at the end of the extruder screws.

Exemplary moisture-curable adhesive compositions according to the disclosure are described in Table 1.

### Examples:

TABLE 1

| | Ex. 1 | Ex. 2 | Ex. 3 | Ex. 4 | Ex. 5 | Ex. 4 |
|---|---|---|---|---|---|---|
| PU Prepolymer | 25.00 | 23.71 | 26.14 | 24.00 | 24.31 | 24.33 |
| DIDP | 23.61 | 24.94 | 19.64 | 22.80 | 22.46 | 25.62 |
| MDI | 3.35 | 5.15 | 4.06 | 4.28 | — | 5.31 |
| H12MDI | — | — | — | 2.20 | — | — |
| TDI | — | — | — | — | 5.24 | — |
| N-Butylamine | 2.10 | 3.10 | 2.44 | 3.80 | — | 3.03 |
| Benzylamine | — | — | — | — | 6.33 | — |
| Fillers | 45.45 | 41.25 | 46.33 | 42.33 | 40.11 | 40.15 |
| Benzoyl chloride | 0.10 | 1.56 | 1.10 | 0.29 | 1.15 | 1.16 |
| Dynasylan Glymo | 0.20 | 0.19 | 0.19 | 0.20 | 0.20 | 0.20 |
| Tin-based catalytic | 0.19 | 0.10 | 0.10 | 0.10 | 0.20 | 0.20 |
| system | | | | | | |
| TOTAL | 100 | 100 | 100 | 100 | 100 | 100 |

1. A process of manufacturing a moisture-curable adhesive composition, wherein the process comprises the steps of:
a) providing a multi-screw extruder comprising a reaction chamber;
b) providing reactants and reagents comprising:
i. at least one isocyanate;
ii. at least one amine; and
iii. optionally, at least one plasticizer;
c) incorporating the reactants and reagents into the reaction chamber of the multi-screw extruder, thereby forming a reaction product comprising a urea derivative; and
d) incorporating at least one moisture-curable prepolymer into the reaction product resulting from step c), thereby forming a moisture-curable adhesive composition.

2. A process according to claim 1, wherein the at least one moisture-curable prepolymer is selected from the group consisting of isocyanate-terminated moisture-curable prepolymers and silane-modified moisture-curable prepolymers.

3. A process according to any of claim 1, wherein the at least one moisture-curable prepolymer is selected from the group consisting of isocyanate-terminated moisture-curable prepolymers.

4. A process according to claim 1, wherein the moisture-curable adhesive composition has a viscosity greater than 100 Pa·s, when measured at 23° C. with a rheometer in a shear flow mode at 0.1 s⁻¹.

5. A process according to claim 1, wherein the urea derivative is a thixotropic agent, having a viscosity greater than 5000 Pa·s when measured at 23° C. with a rheometer in a shear flow mode at 0.1 s⁻¹.

6. A process according to claim 1, wherein the at least one amine is selected from the group consisting of primary aliphatic amines, aromatic monoamines, aromatic diamines, and any combinations or mixtures thereof.

7. A process according to claim 1, wherein the at least one isocyanate is selected from the group consisting of aliphatic diisocyanates, aromatic diisocyanates, and any combinations or mixtures thereof.

8. A process according to claim 1, wherein the urea derivative is a polyfunctional urea derivative, in particular a difunctional urea derivative.

9. A process according to claim 1, wherein the plasticizer is selected from the group consisting of phthalate-based plasticizers, phthalate-free plasticizers, and any mixtures thereof.

10. A process according to claim 1, wherein the multi-screw extruder is selected from the group of twin-screw extruders, planetary roller extruders, and ring extruders.

11. A process according to claim 1, which further comprises the step of incorporating further additives into the reaction product resulting from step c) before the step of incorporating the at least one moisture-curable prepolymer into the reaction product.

12. A process according to claim 11, wherein the additives are selected from the group consisting of organic particulate fillers, inorganic particulate fillers, moisture scavengers, adhesion promoters, and any combinations or mixtures thereof.

13. A process according to claim 1, wherein the moisture-curable adhesive composition comprises:
a) from 2 to 80 wt. % of the reaction product comprising a urea derivative and resulting from step c);
b) from 10 to 50 wt. % of the at least one moisture-curable prepolymer; and
c) optionally, from 10 to 50 wt. % of particulate fillers.

14.-15. (canceled)

16. A process according to claim 12, wherein the inorganic particulate fillers are selected from the group consisting of calcium carbonate, optionally coated with fatty acids or fatty esters; magnesium hydroxides; aluminum oxides; aluminum trihydrates; lime; kaolin; silica-based fillers; titanium dioxide; hollow glass microspheres; and any mixtures thereof.

17. A process according to claim 12, wherein the organic particulate fillers are selected from the group consisting of carbon black, PVC suspensions or emulsions, polyethylene fibers, and any mixtures thereof.

18. A processing according to claim 9, wherein the plasticizer is selected from the group consisting of diisodecyl phthalate (DIDP), diisodecyl terephthalate (DIDT), dibutyl phthalate (DBP), diisobutyl phthalate (DIBP), dibutyl terephthalate (DBT), diisobutyl terephthalate (DIBT), dioctyl phthalate (DOP), dioctyl terephthalate (DOTP), di-ethylhexyl phthalate (DEHP), di-ethylhexyl terephthalate (DEHT), diisononyl phthalate (DINP), diisononyl terephthalate (DINT), diisoundecyl phthalate (DIUP), diisoundecyl terephthalate (DIUT), dimethyl phthalate (DMP), dimethyl terephthalate (DMT), benzyl butyl phthalate (BBP), benzyl butyl terephthalate (BBT), di-ethylhexyl adipate (DEHA), 1,2 cyclohexane dicarboxylic acid diisononyl ester; sulfonate esters; phosphate esters; benzoates; maleate esters; trimellitate esters; and any mixtures thereof.

19. A process according to claim 7, wherein the at least one isocyanate is selected from the group consisting of isophorone diisocyanate (IPDI), hexamethylene diisocyanate (HDI), 4,4′-methylene dicyclohexyl diisocyanate (H12MDI), diphenylmethane diisocyanate (MDI), toluene diisocyanate (TDI), and any mixtures thereof.

20. A process according to claim 6, wherein the at least one amine is selected from the group consisting of N-alkyl amines, benzylamine, and any combinations or mixtures thereof.

21. A process according to claim 1, further comprising pre-mixing the amine and the optional plasticizer in a static mixing element before incorporation into the reaction chamber of the multi-screw extruder.

22. A process according to claim 1, further comprising pre-mixing the isocyanate and the optional plasticizer in a static or dynamic mixing element before incorporation into the reaction chamber of the multi-screw extruder.
